(19) United States
(12) Patent Application Publication
(10) Pub. No.: US 2023/0234232 A1
(43) Pub. Date: Jul. 27, 2023

(54) AUTONOMOUS CONTROL SYSTEM, AUTONOMOUS CONTROL METHOD, AND STORAGE MEDIUM

(71) Applicant: HONDA MOTOR CO., LTD., Tokyo (JP)

(72) Inventors: Akinobu Hayashi, Wako-shi (JP); Itoshi Naramura, Wako-shi (JP)

(21) Appl. No.: 18/096,042

(22) Filed: Jan. 12, 2023

(30) Foreign Application Priority Data
Jan. 24, 2022 (JP) 2022-008713

(51) Int. Cl. B25J 9/16; G05B 19/4155; B25J 13/08

(52) U.S. Cl. CPC B25J 9/1694; G05B 19/4155; B25J 13/084; B25J 9/161; G05B 2219/39369; G05B 2219/40269

(57) ABSTRACT

An autonomous control system includes an acquirer configured to acquire state data of a robot, visual data of the robot, and tactile data of the robot and a processor configured to decide on an action of the robot capable of accomplishing a task given to the robot on the basis of the state data, the visual data, and the tactile data. The processor generates first compressed data having a smaller number of dimensions than data obtained by combining the visual data and the tactile data by fusing and dimensionally compressing the visual data and the tactile data. The processor generates second compressed data having a smaller number of dimensions than the tactile data by dimensionally compressing the tactile data. The processor decides on the action on the basis of combined state data obtained by combining the state data, the first compressed data, and the second compressed data into one.

### CROSS-REFERENCE TO RELATED APPLICATION

This application is based upon and claims the benefit of priority from Japanese Patent Application No. 2022-008713, filed Jan. 24, 2022, the entire content of which is incorporated herein by reference.

### BACKGROUND

### Field of the Invention

The present invention relates to an autonomous control system, an autonomous control method, and a storage medium.

### Description of Related Art

Research is underway to autonomously control robots using machine learning. In this regard, technology for efficiently training a neural network is known (see, for example, Japanese Unexamined Patent Application, First Publication No. 2019-185127).

### SUMMARY

In the related art, when an action of a robot is controlled so that an objective task can be accomplished while the robot's hand is imaged with a camera, if the robot transfers a target object in the hand to another hand or moves or manipulates the target object in the hand, the target object may be covered with its own hand and occlusion may occur. Thus, it may be difficult to estimate a posture of the target object or to determine an action of the robot on the basis of the estimation with only visual information.

Although research is underway to fuse visual and tactile senses of robots using machine learning to solve this problem, it is not sufficient to accomplish an objective task.

The present invention has been made in consideration of such circumstances and an objective thereof is to provide an autonomous control system, an autonomous control method, and a storage medium that enable an objective task to be more easily accomplished.

An autonomous control system, an autonomous control method, and a storage medium according to the present invention adopt the following configurations.

(1) According to a first aspect of the present invention, there is provided an autonomous control system including: an acquirer configured to acquire state data of a robot, visual data of the robot, and tactile data of the robot; and a processor configured to decide (determine) on an action of the robot capable of accomplishing a task given to the robot on the basis of the state data, the visual data, and the tactile data, wherein the processor generates first compressed data having a smaller number of dimensions than data obtained by combining the visual data and the tactile data by fusing and dimensionally compressing the visual data and the tactile data, wherein the processor generates second compressed data having a smaller number of dimensions than the tactile data by dimensionally compressing the tactile data, and wherein the processor decides (determines) on the action on the basis of combined state data obtained by combining the state data, the first compressed data, and the second compressed data into one.

(2) According to a second aspect of the present invention, in the first aspect, the acquirer acquires depth image data generated by a camera that images a body of the robot and a target of the task as the visual data and acquires data in which a contact force detected by each tactile sensor is associated with a distribution of a plurality of tactile sensors arranged in the body as the tactile data, and the processor generates the first compressed data by fusing and dimensionally compressing the distribution of the plurality of tactile sensors and the depth image data.

(3) According to a third aspect of the present invention, in the second aspect, the processor generates the second compressed data by dimensionally compressing the data in which the contact force detected by each tactile sensor is associated with the distribution of the plurality of tactile sensors.

(4) According to a fourth aspect of the present invention, in any one of the first to third aspects, the processor generates the first compressed data from the visual data and the tactile data using a certain first encoder, and the first encoder is a neural network trained on the basis of a first training dataset in which a state of a correct answer of the target of the task is labeled for the visual data and the tactile data.

(5) According to a fifth aspect of the present invention, in any one of the first to fourth aspects, the processor generates the first compressed data from the visual data and the tactile data using a certain first encoder, and the first encoder is a neural network that converts input data into data having a smaller number of dimensions and outputs the data having the smaller number of dimensions and that is trained so that data input to the first encoder matches data output by a decoder in combination with the decoder that converts the input data into data having a larger number of dimensions and outputs the data having the larger number of dimensions.

(6) According to a sixth aspect of the present invention, in any one of the first to fourth aspects, the processor generates the second compressed data from the tactile data using a certain second encoder, and the second encoder is a neural network that converts input data into data having a smaller number of dimensions and outputs the data having the smaller number of dimensions and that is trained so that data input to the second encoder matches data output by a decoder in combination with the decoder that converts the input data into data having a larger number of dimensions and outputs the data having the larger number of dimensions.

(7) According to a seventh aspect of the present invention, in any one of the first to fifth aspects, the processor decides (determines) on the action from the combined state data using reinforcement learning.

(8) According to an eighth aspect of the present invention, in the second or third aspect, the processor further decides (determines) on sensitivity of the tactile sensor on the basis of the combined state data. (9) According to a ninth aspect of the present invention, in the second or third aspect, the processor further decides (determines) on an angle of the camera when the body and the target are imaged on the basis of the combined state data.

(10) According to a tenth aspect of the present invention, there is provided an autonomous control method including: acquiring state data of a robot, visual data of the robot, and tactile data of the robot; deciding on an action of the robot capable of accomplishing a task given to the robot on the basis of the state data, the visual data, and the tactile data; generating first compressed data having a smaller number of dimensions than data obtained by combining the visual data and the tactile data by fusing and dimensionally compressing the visual data and the tactile data; generating second compressed data having a smaller number of dimensions than the tactile data by dimensionally compressing the tactile data; and deciding on the action on the basis of combined state data obtained by combining the state data, the first compressed data, and the second compressed data into one.

(11) According to an eleventh aspect of the present invention, there is provided a computer-readable non-transitory storage medium storing a program for causing a computer to: acquire state data of a robot, visual data of the robot, and tactile data of the robot; decide (determine) on an action of the robot capable of accomplishing a task given to the robot on the basis of the state data, the visual data, and the tactile data; generate first compressed data having a smaller number of dimensions than data obtained by combining the visual data and the tactile data by fusing and dimensionally compressing the visual data and the tactile data; generate second compressed data having a smaller number of dimensions than the tactile data by dimensionally compressing the tactile data; and decide (determine) on the action on the basis of combined state data obtained by combining the state data, the first compressed data, and the second compressed data into one.

According to the above-described aspects, it is possible to more easily accomplish an objective task.

### BRIEF DESCRIPTION OF THE DRAWINGS

FIG. 1 is a diagram showing an example of a configuration of an autonomous control system according to a first embodiment.

FIG. 2 is a diagram schematically showing the appearance of a robot according to the first embodiment.

FIG. 3 is a configuration diagram of the robot and an autonomous control device according to the first embodiment.

FIG. 4 is a flowchart showing a flow of a series of processing steps of a processor according to the first embodiment.

FIG. 5 is a diagram schematically showing the flow of the series of processing steps of the processor according to the first embodiment.

FIG. 6 is a configuration diagram of a learning device according to the first embodiment.

FIG. 7 is a diagram for describing a method of training a first encoder.

FIG. 8 is a diagram for describing a method of training a second encoder.

FIG. 9 is a diagram for describing another method of training the first encoder.

FIG. 10 is a flowchart showing a flow of a series of processing steps of a processor according to a second embodiment.

FIG. 11 is a diagram schematically showing the flow of the series of processing steps of the processor according to the second embodiment.

### DESCRIPTION OF EMBODIMENTS

Hereinafter, embodiments of an autonomous control system, an autonomous control method, and a storage medium of the present invention will be described with reference to the drawings.

### First Embodiment

### [Configuration of System]

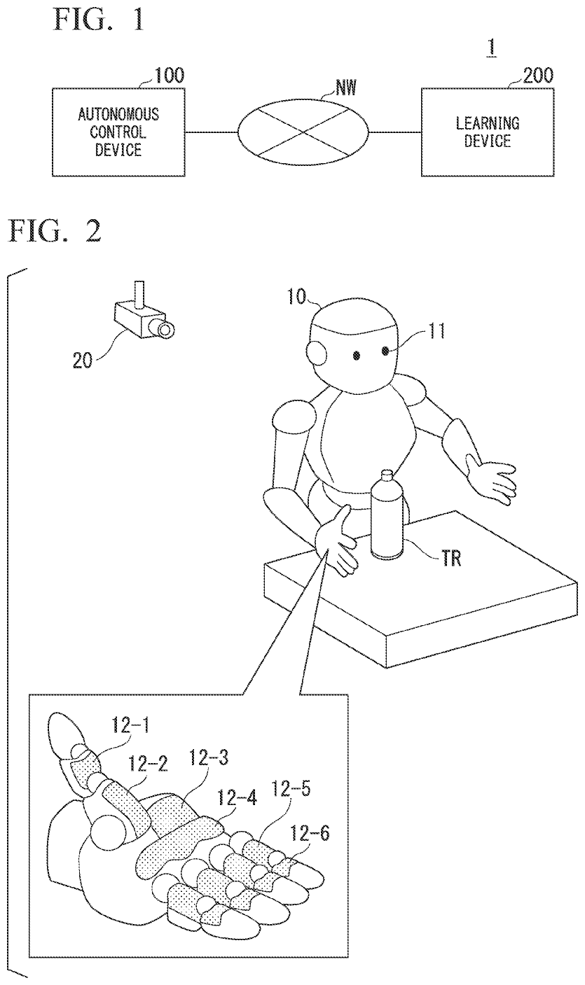

FIG. 1 is a diagram showing an example of a configuration of an autonomous control system 1 according to a first embodiment. The autonomous control system 1 includes, for example, an autonomous control device 100 and a learning device 200. The autonomous control device 100 and the learning device 200 are connected via a network NW. The network NW includes a local area network (LAN), a wide area network (WAN), or the like.

The autonomous control device 100 is a device that performs autonomous control so that the robot 10 acts autonomously. The autonomous control device 100 is typically mounted in a robot 10 and directly controls the robot 10. Also, the autonomous control device 100 may be installed at a remote location far away from the robot 10 and may remotely control the robot 10 via the network NW. For example, the autonomous control device 100 decides (determines) on an optimal action that the robot 10 should take using a machine learning model.

The learning device 200 is a device that trains the machine learning model that is used by the autonomous control device 100. The learning device 200 may be a single device or may be one system in which a plurality of devices connected via the network NW operate in cooperation with each other. That is, the learning device 200 may be implemented by a plurality of computers (processors) included in a distributed computing system or a cloud computing system.

### [Appearance of Robot]

FIG. 2 is a diagram schematically showing the appearance of the robot 10 according to the first embodiment. The robot 10 is typically a humanoid robot having two hands, but is not limited thereto, and may be a quadrupedal animal robot, an industrial robot, a military robot, a household cleaning robot, or any of various other robots that can act autonomously.

For example, the robot 10 includes a visual sensor 11 for imaging an external environment as seen by the robot 10 and a plurality of tactile sensors 12 that reproduce the robot's tactile sense, and the robot 10 performs the objective task according to the action decided (determined) on by the autonomous control device 100 using these sensors.

For example, if a target TR such as a polyethylene terephthalate (PET) bottle is considered, a task is to grip the PET bottle with one hand, transfer the PET bottle to the other hand, move the PET bottle, remove the cap from the PET bottle, or put the cap on the PET bottle. The task is not limited to these and any task can be set.

The visual sensor 11 is installed on a part of the body of the robot 10 (typically a head). The visual sensor 11 may be, for example, a depth camera. The depth camera images the view in front of the robot 10 and generates a colorful three-dimensional image (i.e., a six-dimensional image of width (W), height (H), red (R), green (G), blue (B), and depth (D)). Also, the visual sensor 11 is not limited to the depth camera, and may be, for example, a sensor such as a radar or lidar sensor that images an external environment by emitting electromagnetic waves. Hereinafter, for the sake of convenience, the visual sensor 11 is assumed to be the depth camera as an example. When a monitoring camera 20 is located in the work space of the robot 10 and the depth camera can be substituted with the monitoring camera 20, the visual sensor 11 may be omitted.

The plurality of tactile sensors 12 are distributed and arranged, for example, on a part of the body of the robot 10 (typically fingers and palms). Specifically, the tactile sensors 12 may be distributed in 10 areas within fingers or palms. For example, tactile sensors 12-1 and 12-2 capable of detecting a contact force at 32 points are arranged in the thumb. The contact force is, for example, a physical force such as pressure, stress, or strain. Tactile sensors 12-3 and 12-4 capable of detecting a contact force at 32 points are arranged on the palm. A tactile sensor 12-5 capable of detecting a contact force at 24 points and a tactile sensor 12-6 capable of detecting a contact force at 8 points are installed on the remaining four fingers other than the thumb. The plurality of tactile sensors 12 arranged in such a distribution detect forces applied to the fingers and the palms when the target TR is gripped, using a total of 224 channels. Also, the number of channels is not limited to 224 and may be, for example, several tens to several hundreds.

### [Configuration of Robot and Autonomous Control Device]

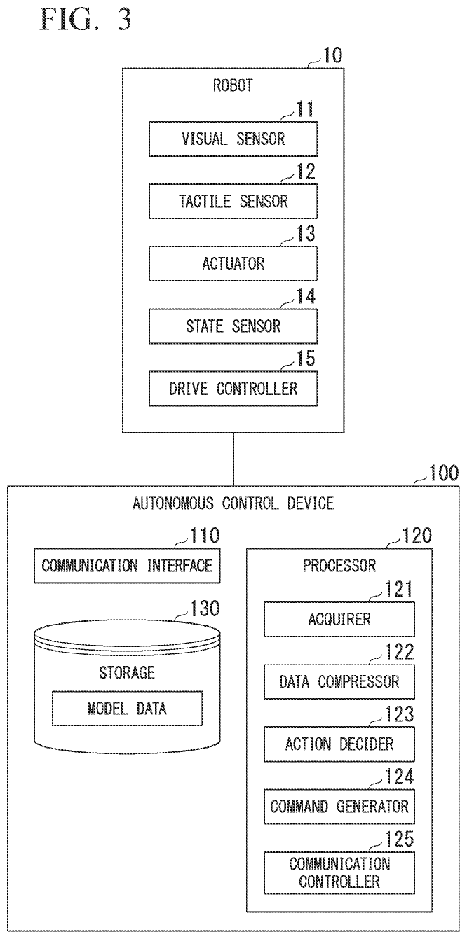

FIG. 3 is a configuration diagram of the robot 10 and the autonomous control device 100 according to the first embodiment. The robot 10 further includes an actuator 13, a state sensor 14, and a drive controller 15 in addition to the visual sensor 11 and the tactile sensor 12 described above.

The actuator 13 drives parts (arms, fingers, legs, a head, a torso, a waist, and the like) of the robot 10 under the control of the drive controller 15. The actuator 13 includes, for example, an electromagnetic motor, a gear, artificial muscles, and the like.

The state sensor 14 is a sensor that detects a state of the robot 10 (for example, a joint angle, an angular velocity, torque, or the like). The state sensor 14 includes, for example, a rotary encoder that detects a degree of rotation of a joint of the robot 10, a tension sensor that detects a tension of a wire for rotating the joint, a torque sensor that detects torque applied to a joint shaft, an acceleration sensor or a gyro sensor for detecting a posture of the robot 10, or the like.

The drive controller 15 controls the actuator 13 on the basis of a control command generated by the autonomous control device 100.

The autonomous control device 100 includes, for example, a communication interface 110, a processor 120, and a storage 130.

The communication interface 110 communicates with the learning device 200 via the network NW and communicates with the robot 10 via a communication line such as a bus. The communication interface 110 includes, for example, a wireless communication module including a receiver and a transmitter, a network interface card (NIC), and the like.

The processor 120 includes, for example, an acquirer 121, a data compressor 122, an action decider (action determiner) 123, a command generator 124, and a communication controller 125.

The components of the processor 120 are implemented, for example, by a central processing unit (CPU) or a graphics processing unit (GPU) executing a program stored in the storage 130. Some or all of these components may be implemented by hardware such as a large-scale integration (LSI) circuit, an application-specific integrated circuit (ASIC), or a field-programmable gate array (FPGA) or may be implemented by software and hardware in cooperation.

The storage 130 is implemented by a hard disk drive (HDD), a flash memory, an electrically erasable programmable read-only memory (EEPROM), a read-only memory (ROM), a random-access memory (RAM), or the like. The storage 130 stores model data in addition to various types of programs such as firmware and application programs. The model data is data (a program or an algorithm) in which some machine learning models for deciding on the action of the robot 10 are defined. For example, the model data from the learning device 200 may be installed in the storage 130 via the network NW or the model data from a portable storage medium connected to the drive device of the autonomous control device 100 may be installed in the storage 130.

### [Processing Flow of Autonomous Control Device]

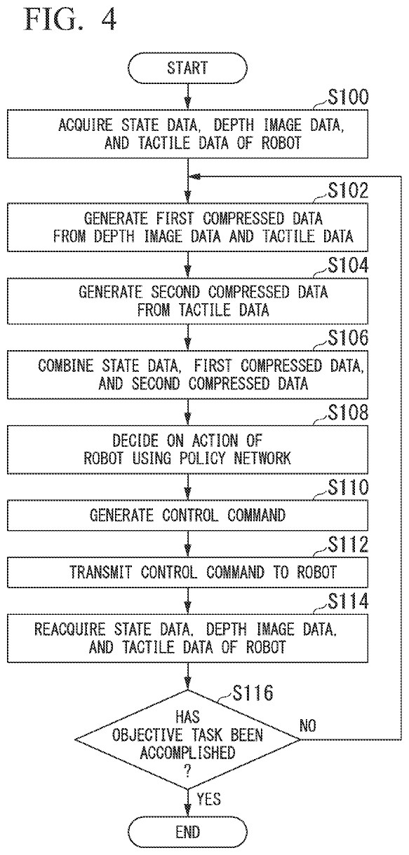

Each component of the processor 120 will be described below using a flowchart. FIG. 4 is a flowchart showing a series of processing steps of the processor 120 according to the first embodiment.

First, the acquirer 121 acquires state data, depth image data, and tactile data from the robot 10 via the communication interface 110 (step S100).

The state data is, for example, a multidimensional vector including detection values of the state sensor 14 of the robot 10 as elements. Hereinafter, a vector of the state data is specifically referred to as a “state vector.” The state vector includes, for example, the joint angle detected by the rotary encoder, the tension of the joint wire detected by the tension sensor, the torque of the joint shaft detected by the torque sensor, the acceleration of the robot 10 detected by the acceleration sensor, the angular velocity of the robot 10 detected by the gyro sensor, and the like as element values.

The depth image data is, for example, a vector of a colorful three-dimensional image (a six-dimensional image) obtained by the visual sensor 11 of the robot 10. Hereinafter, a vector of the depth image data is specifically referred to as an “image vector.” For example, four-dimensional information in which depth (D) and RGB values are associated for each pixel of an image represented by width (W) and height (H) is projected onto XYZ world coordinates and a six-dimensional vector represented by RGB-XYZ after the projection becomes an image vector. Also, when the image obtained by the visual sensor 11 is black and white, the image vector is a four-dimensional vector in which a pixel value of one channel is associated with XYZ.

For example, it is assumed that the depth camera images the robot 10 gripping the target TR to accomplish a task. In this case, the depth image data includes one or both of (i) distance information and color information in a range from the depth camera mounted on the robot 10 to the hand of the robot 10 and (ii) distance information and color information in a range from the depth camera mounted on the robot 10 to the target TR.

When the monitoring camera 20 is located in the work space of the robot 10, the acquirer 121 may acquire the depth image data from the monitoring camera 20 in addition to or instead of acquiring the depth image data from the robot 10. In this case, the depth image data may include one or both of (iii) distance information and color information in a range from the monitoring camera 20 to the hand of the robot 10 and (iv) distance information and color information in a range from the monitoring camera 20 to the target TR.

The tactile data is, for example, a multidimensional vector in which the contact force detected by each tactile sensor 12 is associated with a distribution (a contact point group) of the plurality of tactile sensors 12 arranged on a part of the body of the robot 10. Hereinafter, a vector of the tactile data is specifically referred to as a “tactile vector.” For example, in the example of FIG. 2, the tactile vector is a 224-dimensional vector. However, the tactile vector may be a vector of several tens to several hundreds of dimensions as described above.

Subsequently, the data compressor 122 generates data (hereinafter referred to as first compressed data) having a smaller number of dimensions than a combination of the depth image data (the image vector) and the tactile data (the tactile vector) by fusing and dimensionally compressing the depth image data (the image vector) and the tactile data (the tactile vector) among the state data (the state vector), the depth image data (the image vector), and the tactile data (the tactile vector) acquired by the acquirer 121 (step S102).

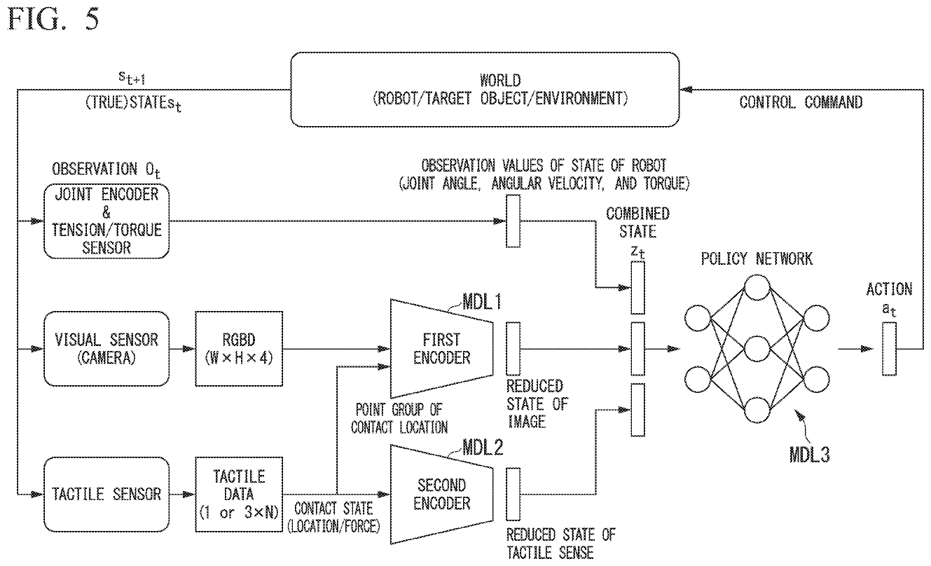

FIG. 5 is a diagram schematically showing a flow of a series of processing steps of the processor 120 according to the first embodiment. In FIG. 5, MDL1 denotes a first encoder (an autoencoder) pre-trained to dimensionally compress the input data and MDL2 denotes a second encoder (an autoencoder) pre-trained to dimensionally compress the input data like the first encoder MDL1. MDL3 denotes a policy network pre-trained to decide (determine) on the action of the robot 10 from the state data.

The first encoder MDL1 and/or the second encoder MDL2 may be implemented, for example, by a neural network including a convolutional layer.

The policy network MDL3 is a network that uses deep reinforcement learning. Several types of deep reinforcement learning such as, for example, a value-based model, a policy-based model, an Actor-Critic model based on a combination of a value and policy and a predictive model-based model, are known. For example, twin delayed deep deterministic policy gradient (DDPG) (TD3), soft Actor-Critic (SAC), and the like are included in the Actor-Critic model. In the present embodiment, for example, the policy-based model, the Actor-Critic model, the predictive model-based model, and the like can be applied.

These various types of models are defined by model data stored in the storage 130. The model data includes, for example, various types of information such as combination information about how units included in each of a plurality of layers constituting a neural network are combined with each other and a combination coefficient given to data that is input and output between the combined units. The combination information includes, for example, the number of units included in each layer, information for designating a type of unit with which each unit is combined, an activation function of implementing each unit, a gate provided between hidden layer units, and the like. The activation function for implementing the unit may be, for example, a normalized linear function (a rectified linear unit (ReLU) function), a sigmoid function, a step function, other functions, or the like. The gate causes data communicated between units to selectively pass through or to be weighted, for example, in accordance with a value (e.g., 1 or 0) returned by the activation function. A combination coefficient includes, for example, a weight given to output data when data is output from a unit of a certain layer to a unit of a deeper layer in a hidden layer of a neural network. The combination coefficient may include a unique bias component of each layer or the like.

For example, the data compressor 122 projects depth image data (W (image size-specific width)×H (image size-specific height)×D (depth)) onto the XYZ world coordinates. Further, the data compressor 122 projects a contact point of the tactile sensor 12 (a point where a contact force greater than or equal to a threshold value is detected within a point group for 224 channels) onto the XYZ world coordinates. The data compressor 122 sets a vector obtained by combining the point group derived from the depth image data projected onto the world coordinates and the contact point of the tactile sensor 12 as one vector and inputs the vector to the trained first encoder MDL1. In response to this, the trained first encoder MDL1 outputs state data (a state vector) indicating the state such as a location or a posture of the target TR as first compressed data.

In other words, the first encoder MDL1 is trained to supplement the determination of the location or the posture of the target TR in the hand of the robot 10 from the contact point of the tactile sensor 12 even if it is difficult to determine the location or the posture of the target TR from the viewpoint of the robot 10 using depth image data alone (i.e., even if the occlusion occurs) because a part or all of the target TR is covered with the hand of the robot 10 or the like.

Returning to the description of the flowchart of FIG. 4, next, the data compressor 122 generates data (hereinafter referred to as second compressed data) having a smaller number of dimensions than the tactile data (the tactile vector) by dimensionally compressing the tactile data (the tactile vector) among the state data (the state vector), the depth image data (the image vector), and the tactile data (the tactile vector) acquired by the acquirer 121 (step S104).

As shown in FIG. 5, for example, the data compressor 122 inputs the tactile data (the tactile vector) in which the contact force detected by each tactile sensor 12 is associated with the distribution of the plurality of tactile sensors 12 (the contact point group) to the trained second encoder MDL2. In response to this, the trained second encoder MDL2 converts, for example, a 224-dimensional tactile vector into a tactile vector of several tens of dimensions such as 10 or 20 dimensions, and outputs the tactile vector of the several tens of dimensions as second compressed data.

Returning to the description of the flowchart of FIG. 4, next, the action decider 123 generates data (hereinafter referred to as combined state data) by combining the state data (the state vector), the first compressed data, and the second compressed data into one (step S106).

Subsequently, the action decider 123 decides on the action of the robot 10 from the combined state data using the policy network MDL3 (step S108).

As shown in FIG. 5, for example, the action decider 123 inputs combined state data (zₜ in FIG. 5) having a smaller number of dimensions obtained by compressing an observation result oₜ using the first encoder MDL1 and the second encoder MDL2 to the policy network MDL3 without inputting the state data (the state vector), the depth image data (the image vector), and the tactile data (the tactile vector) as an observation result oₜ of an environmental state sₜ at certain time t to the policy network MDL3 as they are. In response to this, the policy network MDL3 outputs an action (an action variable) aₜ having a maximum value (Q value) among one or more actions (action variables) aₜ capable of being taken by the robot 10 under the environmental state sₜ at certain time t. The action (the action variable) aₜ may be one of various actions such as, for example, gripping the target TR, changing the grip, and moving the target TR. The action aₜ to be output to the policy network MDL3 is appropriately learned according to the task required for the robot 10.

Returning to the description of the flowchart of FIG. 4, next, the command generator 124 generates a control command for controlling each actuator 13 of the robot 10 on the basis of the action at of the robot 10 decided on using the policy network MDL3 (step S110).

Subsequently, the communication controller 125 transmits a control command to the robot 10 via the communication interface 110 (step S112). When the control command is received, the drive controller 15 of the robot 10 controls the actuator 13 on the basis of the control command Thereby, the robot 10 acts, the target TR is lifted or moved, and the environmental state sₜ surrounding the robot 10 changes to sₜ₊₁.

Subsequently, the acquirer 121 reacquires the state data, the depth image data, and the tactile data from the robot 10 via the communication interface 110 (step S114). That is, the acquirer 121 reacquires the state data (the state vector), the depth image data (the image vector), and the tactile data (the tactile vector) as an observation result oₜ₊₁ of the environmental state sₜ₊₁ at time t+1.

The processor 120 determines whether or not the objective task has been accomplished on the basis of various types of data reacquired from the robot 10 (i.e., the observation result oₜ₊₁) (step S116). In other words, the processor 120 determines whether or not the environmental state sₜ₊₁ at time t+1 is in a desired state in which the robot 10 has accomplished the objective task.

When the objective task has been accomplished (when the environmental state sₜ₊₁ is in the desired state), the process of the flowchart ends.

On the other hand, when the objective task has not been accomplished (the environmental state sₜ₊₁ is not in the desired state), the processor 120 returns the process to S102 described above and iterates a series of processing steps from S102 to S114 until the objective task is accomplished. Thereby, the process of the present flowchart ends.

### [Configuration of Learning Device]

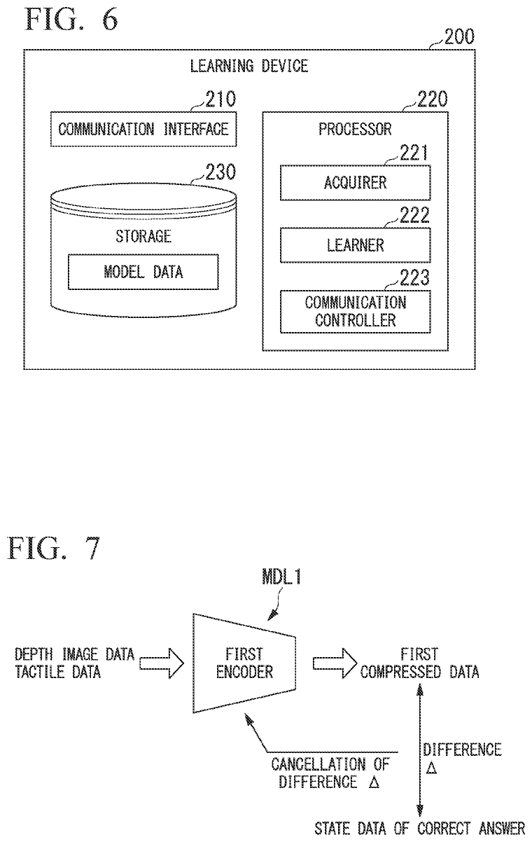

A configuration of the learning device 200 according to the first embodiment will be described below. FIG. 6 is a configuration diagram of the learning device 200 according to the first embodiment. The learning device 200 includes, for example, a communication interface 210, a processor 220, and a storage 230.

The communication interface 210 communicates with the autonomous control device 100 via the network NW. The communication interface 210 includes, for example, a wireless communication module including a receiver and transmitter, an NIC, and the like.

The processor 220 includes, for example, an acquirer 221, a learner 222, and a communication controller 223.

The components of the processor 220 are implemented, for example, by a CPU or a GPU executing a program stored in the storage 230. Some or all of these components may be implemented by hardware such as an LSI circuit, an ASIC, or an FPGA or may be implemented by software and hardware in cooperation.

The storage 230 is implemented by, for example, an HDD, a flash memory, an EEPROM, a ROM, a RAM, and the like. The storage 230 stores model data in which an untrained first encoder MDL1, an untrained second encoder MDL2, and an untrained policy network MDL3 are defined in addition to various types of programs such as firmware and application programs.

The acquirer 221 acquires a training dataset for training the untrained first encoder MDL1.

The training dataset is a dataset in which the state data (the state vector) of the target TR of the correct answer (ideal) to be output by the first encoder MDL1 is labeled for the depth image data (the image vector) and the tactile data (the tactile vector) provided for training. In other words, the training dataset is a dataset in which the depth image data (the image vector) and the tactile data (tactile vector) are used as input data and the state data (the state vector) of the target TR of the correct answer is used as output data.

For example, the acquirer 221 may acquire a training dataset from another device (for example, a data source) via the communication interface 210. Also, when the training dataset is already stored in the storage 230, the acquirer 221 may read the training dataset from the storage 230. Furthermore, when a non-transitory storage medium (such as a fresh memory) storing a training dataset has been connected to the drive device of the learning device 200, the acquirer 221 may read the training dataset from the storage medium.

The learner 222 trains the first encoder MDL1 using the training dataset acquired by the acquirer 221.

FIG. 7 is a diagram for describing a method of training the first encoder MDL1. For example, the learner 222 inputs depth image data (an image vector) and tactile data (a tactile vector) included in a training dataset as input data to the untrained first encoder MDL1.

In accordance with the input of the depth image data (the image vector) and the tactile data (the tactile vector), the untrained first encoder MDL1 compresses a number of dimensions of the data and outputs the compressed data as first compressed data.

The learner 222 calculates a difference A between the first compressed data output by the untrained first encoder MDL1 and the state data (the state vector) of the target TR included as output data in the training dataset. The learner 222 decides on (updates) a weighting factor, a bias component, and the like, which are the parameters of the first encoder MDL1, using a stochastic gradient descent method or the like so that the difference Δ becomes small.

The learner 222 further trains the second encoder MDL2.

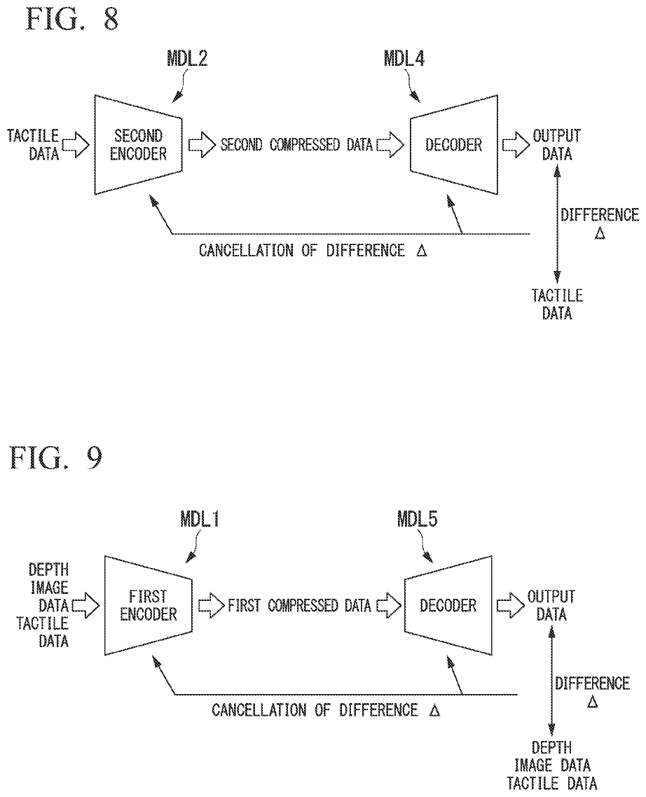

FIG. 8 is a diagram for describing a method of training the second encoder MDL2. A decoder MDL4 functionally paired with the second encoder MDL2 is used for training the second encoder MDL2. As described above, the second encoder MDL2 is a neural network that converts input data into data having a smaller number of dimensions and outputs the data. On the other hand, the decoder MDL4 is a neural network that converts input data into data having a larger number of dimensions and outputs the data.

The learner 222 inputs the tactile data (the tactile vector) provided for training to the untrained second encoder MDL2. In accordance with the input of the tactile data (the tactile vector), the untrained second encoder MDL2 compresses a number of dimensions of the tactile data (the tactile vector) and outputs the compressed data as second compressed data.

The second compressed data output by the second encoder MDL2 is input to the untrained decoder MDL4. In accordance with the input of the second compressed data, the untrained decoder MDL4 converts the second compressed data into data having a larger number of dimensions and outputs the data.

The learner 222 calculates a difference A between the tactile data (the tactile vector) input to the second encoder MDL2 and the data having the larger number of dimensions output by the decoder MDL4. The learner 222 decides on (updates) a weighting factor, a bias component, and the like, which are the parameters of the second encoder MDL2 and the decoder MDL4, using a stochastic gradient descent method or the like so that the difference A becomes small. That is, the learner 222 trains the second encoder MDL2 and the decoder MDL4 so that the tactile data (the tactile vector) input to the second encoder MDL2 matches the data having the larger number of dimensions output by the decoder MDL4.

The learner 222 further trains the policy network MDL3. For example, when the policy network MDL3 is policy-based, the learner 222 may train the policy network MDL3 using policy gradients or the like. Also, for example, when the policy network MDL3 is Actor-Critic, the learner 222 trains the Actor (actor) that decides on the action and also trains the Critic (evaluator) that evaluates the policy at the same time.

The communication controller 223 transmits model data in which the first encoder MDL1, the second encoder MDL2, and the policy network MDL3 trained by the learner 222 are defined to the autonomous control device 100 via the communication interface 210. Thereby, the autonomous control device 100 can decide on the action of the robot 10 using each trained model.

According to the above-described embodiment, the autonomous control device 100 generates first compressed data having a smaller number of dimensions by fusing and dimensionally compressing the depth image data (the image vector) and the tactile data (the tactile vector) using the first encoder MDL1. The autonomous control device 100 generates second compressed data having a smaller number of dimensions by dimensionally compressing the tactile data (the tactile vector) using the second encoder MDL2. The autonomous control device 100 generates combined state data zₜ by combining the state data (the state vector), the first compressed data, and the second compressed data of the robot 10 into one and decides on an action aₜ of the robot 10 capable of accomplishing a task from the combined state data zₜ using the policy network MDL3. Thus, it is possible to improve the accuracy of the policy network MDL3 by compressing a number of dimensions of the data input to the policy network MDL3 using the first encoder MDL1 and the second encoder MDL2. As a result, an objective task becomes more achievable.

Also, according to the above-described first embodiment, because the first encoder MDL1, the second encoder MDL2, and the policy network MDL3 are separated and trained individually, it is possible to improve the accuracy of each model while improving the learning efficiency.

### Modified Example of First Embodiment

Although a case in which the learner 222 trains the first encoder MDL1 using the training dataset in the above-described first embodiment, the present invention is not limited to this. For example, in the learner 222, a method of training the first encoder MDL1 may be the same as a method of training the second encoder MDL2.

FIG. 9 is a diagram for describing another method of training the first encoder MDL1. As in the training of the second encoder MDL2, in the training of the first encoder MDL1, a decoder MDLS functionally paired with the first encoder MDL1 is used. As described above, the first encoder MDL1 is a neural network that converts input data into data having a smaller number of dimensions and outputs the data. On the other hand, the decoder MDLS is a neural network that converts input data into data having a larger number of dimensions and outputs the data.

The learner 222 inputs depth image data (an image vector) and tactile data (a tactile vector) provided for training to the untrained first encoder MDL1. In accordance with the input of the depth image data (the image vector) and the tactile data (the tactile vector), the untrained first encoder MDL1 compresses a number of dimensions of the data and outputs the compressed data as first compressed data.

The first compressed data output by the first encoder MDL1 is input to the untrained decoder MDLS. In accordance with the input of the first compressed data, the untrained decoder MDLS converts the first compressed data into data having a larger number of dimensions and outputs the data.

The learner 222 calculates a difference Δ between the depth image data (the image vector) and the tactile data (the tactile vector) input to the first encoder MDL1 and the data having the larger number of dimensions output by the decoder MDLS. The learner 222 decides on (updates) a weighting factor, a bias component, and the like, which are the parameters of the first encoder MDL1 and the decoder MDLS, using a stochastic gradient descent method or the like so that the difference A becomes small. That is, the learner 222 trains the first encoder MDL1 and the decoder MDLS so that the depth image data (the image vector) and the tactile data (the tactile vector) input to the first encoder MDL1 match the data having the larger number of dimensions output by the decoder MDLS.

### Second Embodiment

A second embodiment will be described below. The second embodiment is different from the above-described first embodiment in that the policy network MDL3 outputs a sensitivity parameter of the tactile sensor 12 in addition to an action aₜ of the robot 10. The sensitivity parameter is a parameter for adjusting the sensitivity of the tactile sensor 12. For example, at each contact point of the tactile sensor 12, the sensitivity parameter is a threshold value at a boundary of a contact force between whether or not there is contact. Also, the sensitivity parameter may be a gradient of the contact force in addition to or instead of the threshold value. Hereinafter, differences from the first embodiment will be mainly described and description that is the same as that of the first embodiment will be omitted. In the description of the second embodiment, parts that are the same as those of the first embodiment are denoted by the same reference signs.

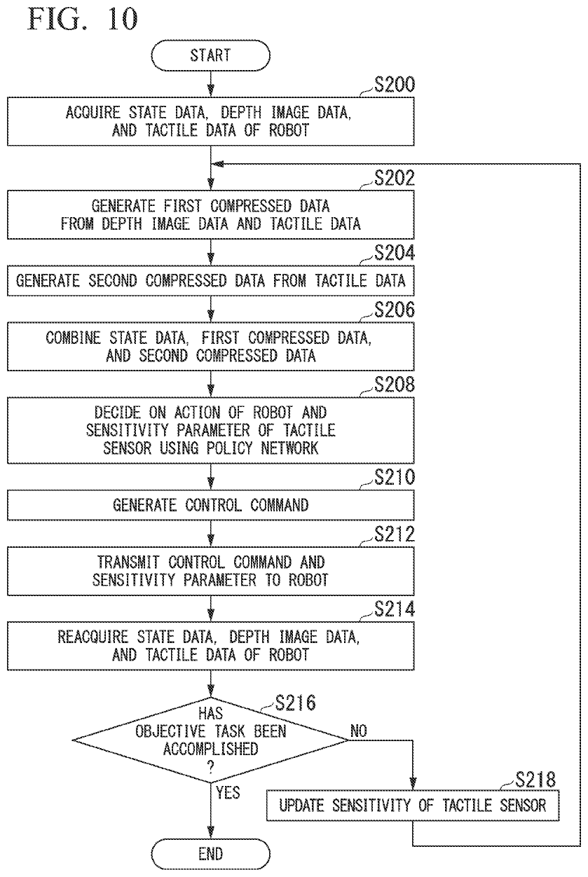

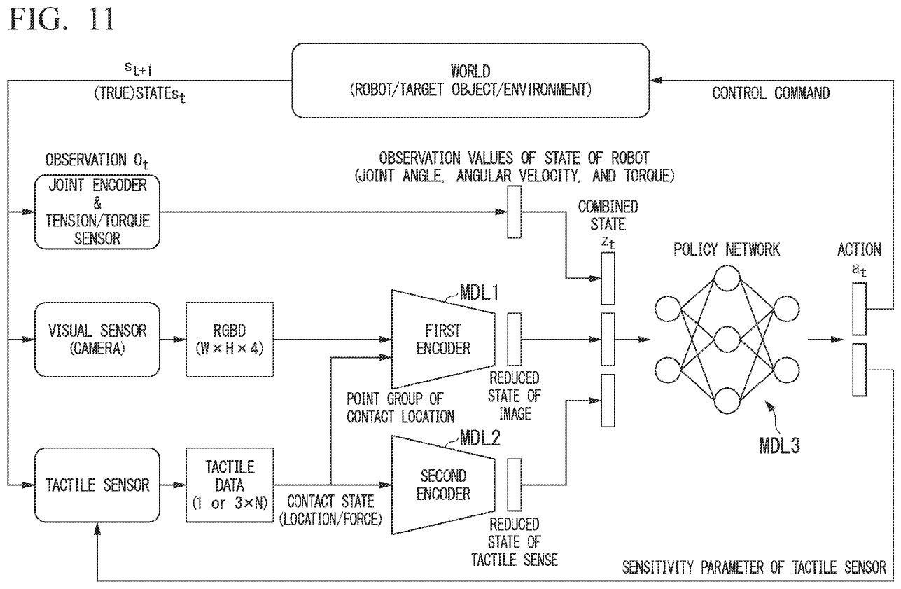

FIG. 10 is a flowchart showing a flow of a series of processing steps of the processor 120 according to the second embodiment. FIG. 11 is a diagram schematically showing the flow of the series of processing steps of the processor 120 according to the second embodiment.

First, the acquirer 121 acquires state data, depth image data, and tactile data from the robot 10 via the communication interface 110 (step S200).

Subsequently, the data compressor 122 generates first compressed data by fusing and dimensionally compressing the depth image data (an image vector) and the tactile data (a tactile vector) among the state data (a state vector), the depth image data (the image vector), and the tactile data (the tactile vector) acquired by the acquirer 121 (step S202).

Subsequently, the data compressor 122 generates second compressed data by dimensionally compressing the tactile data (the tactile vector) among the state data (the state vector), the depth image data (the image vector), and the tactile data (the tactile vector) acquired by the acquirer 121 (step S204).

Subsequently, the action decider 123 generates combined state data zₜ by combining the state data (the state vector), the first compressed data, and the second compressed data into one (step S206) and decides on the action aₜ of the robot 10 and the sensitivity parameter of the tactile sensor 12 from the combined state data zₜ using the policy network MDL3 (step S208). It is assumed that the policy network MDL3 has been pre-trained so that the action aₜ and the sensitivity parameter are output.

Subsequently, the command generator 124 generates a control command for controlling each actuator 13 of the robot 10 on the basis of the action aₜ of the robot 10 decided on using the policy network MDL3 (step S210).

Subsequently, the communication controller 125 transmits the control command and the sensitivity parameter of the tactile sensor 12 to the robot 10 via the communication interface 110 (step S212). When the control command is received, the drive controller 15 of the robot 10 controls the actuator 13 on the basis of the control command Thereby, the robot 10 acts and the environmental state sₜ surrounding the robot 10 changes to sₜ₊₁.

Subsequently, the acquirer 121 reacquires the state data, the depth image data, and the tactile data from the robot 10 via the communication interface 110 (step S214). That is, the acquirer 121 reacquires the state data (the state vector), the depth image data (the image vector), and the tactile data (the tactile vector) as an observation result oₜ₊₁ of the environmental state sₜ₊₁ at time t+1.

The processor 120 determines whether or not the objective task has been accomplished on the basis of various types of data reacquired from the robot 10 (i.e., the observation result oₜ₊₁) (step S216). In other words, the processor 120 determines whether or not he environmental state sₜ₊₁ at time t+1 is in a desired state in which the robot 10 has accomplished the objective task.

When the objective task has been accomplished (when the environmental state sₜ₊₁ is in the desired state), the process of the present flowchart ends.

On the other hand, when the objective task has not been accomplished (when the environmental state sₜ₊₁ is not in the desired state), the drive controller 15 of the robot 10 updates the sensitivity of the tactile sensor 12 in accordance with the sensitivity parameter of the tactile sensor 12 (step S218). The processor 120 returns the process to S202 described above and iterates the series of processing steps from S202 to S218 until the objective task is accomplished. Thereby, the process of the present flowchart ends.

According to above-described second embodiment, the autonomous control device 100 further decides on a sensitivity parameter of the tactile sensor 12 in addition to the decision of the action aₜ of the robot 10 capable of accomplishing the task from the combined state data zₜ using the policy network MDL3. Thereby, because the sensitivity of the tactile sensor 12 of the robot 10 is adjusted so that the task can be accomplished, the objective task can be accomplished more easily than in the first embodiment.

For example, when the threshold value decided on as the sensitivity parameter is small and the sensitivity of the tactile sensor 12 is set as high sensitivity, it is possible to detect a force with high accuracy even if a small force is applied to the tactile sensor 12. As a result, even if the target TR is, for example, a hairpin placed on a table, the hairpin can be found only with a tactile sense.

On the other hand, for example, when the threshold value decided on as the sensitivity parameter is large and the sensitivity of the tactile sensor 12 is set as low sensitivity, it is possible to detect a force with high accuracy even if a large force is applied to the tactile sensor 12. As a result, for example, even if the lid of a bottle is tightly closed, the lid can be opened forcefully.

Although a case where the sensitivity parameter of the tactile sensor 12 is decided on in addition to deciding on the action aₜ of the robot 10 from the combined state data zₜ has been described in the above-described second embodiment, the present invention is not limited to this. For example, in addition to the action aₜ of the robot 10 and/or the sensitivity parameter of the tactile sensor 12, an angle of the visual sensor 11 (the depth camera) when the body of the robot 10 and the target TR are imaged may be further decided on.

The embodiment described above can be represented as follows.

An autonomous control system including:

a storage medium storing computer-readable instructions; and

a processor connected to the storage medium,

wherein the processor executing the computer-readable instructions to:

acquire state data of a robot, visual data of the robot, and tactile data of the robot;

decide on an action of the robot capable of accomplishing a task given to the robot on the basis of the state data, the visual data, and the tactile data;

generate first compressed data having a smaller number of dimensions than data obtained by combining the visual data and the tactile data by fusing and dimensionally compressing the visual data and the tactile data;

generate second compressed data having a smaller number of dimensions than the tactile data by dimensionally compressing the tactile data; and

decide on the action on the basis of combined state data obtained by combining the state data, the first compressed data, and the second compressed data into one.

Although modes for carrying out the present invention have been described above using embodiments, the present invention is not limited to the embodiments and various modifications and substitutions can also be made without departing from the scope and spirit of the present invention.

What is claimed is:

1. An autonomous control system comprising:
an acquirer configured to acquire state data of a robot, visual data of the robot, and tactile data of the robot; and
a processor configured to decide on an action of the robot capable of accomplishing a task given to the robot on the basis of the state data, the visual data, and the tactile data,
wherein the processor generates first compressed data having a smaller number of dimensions than data obtained by combining the visual data and the tactile data by fusing and dimensionally compressing the visual data and the tactile data,
wherein the processor generates second compressed data having a smaller number of dimensions than the tactile data by dimensionally compressing the tactile data, and
wherein the processor decides on the action on the basis of combined state data obtained by combining the state data, the first compressed data, and the second compressed data into one.

2. The autonomous control system according to claim 1,
wherein the acquirer acquires depth image data generated by a camera that images a body of the robot and a target of the task as the visual data and acquires data in which a contact force detected by each tactile sensor is associated with a distribution of a plurality of tactile sensors arranged in the body as the tactile data, and
wherein the processor generates the first compressed data by fusing and dimensionally compressing the distribution of the plurality of tactile sensors and the depth image data.

3. The autonomous control system according to claim 2, wherein the processor generates the second compressed data by dimensionally compressing the data in which the contact force detected by each tactile sensor is associated with the distribution of the plurality of tactile sensors.

4. The autonomous control system according to claim 1,
wherein the processor generates the first compressed data from the visual data and the tactile data using a first encoder, and
wherein the first encoder is a neural network trained on the basis of a training dataset in which a state of a correct answer of the target of the task is labeled for the visual data and the tactile data.

5. The autonomous control system according to claim 1,
wherein the processor generates the first compressed data from the visual data and the tactile data using a first encoder, and
wherein the first encoder is a neural network that converts input data into data having a smaller number of dimensions and outputs the data having the smaller number of dimensions and that is trained so that data input to the first encoder matches data output by a decoder in combination with the decoder that converts the input data into data having a larger number of dimensions and outputs the data having the larger number of dimensions.

6. The autonomous control system according to claim 1,
wherein the processor generates the second compressed data from the tactile data using a second encoder, and
wherein the second encoder is a neural network that converts input data into data having a smaller number of dimensions and outputs the data having the smaller number of dimensions and that is trained so that data input to the second encoder matches data output by a decoder in combination with the decoder that converts the input data into data having a larger number of dimensions and outputs the data having the larger number of dimensions.

7. The autonomous control system according to claim 1, wherein the processor decides on the action from the combined state data using reinforcement learning.

8. The autonomous control system according to claim 2, wherein the processor further decides on sensitivity of the tactile sensor on the basis of the combined state data.

9. The autonomous control system according to claim 2, wherein the processor further decides on an angle of the camera when the body and the target are imaged on the basis of the combined state data.

10. An autonomous control method comprising:
acquiring state data of a robot, visual data of the robot, and tactile data of the robot;
deciding on an action of the robot capable of accomplishing a task given to the robot on the basis of the state data, the visual data, and the tactile data;
generating first compressed data having a smaller number of dimensions than data obtained by combining the visual data and the tactile data by fusing and dimensionally compressing the visual data and the tactile data;
generating second compressed data having a smaller number of dimensions than the tactile data by dimensionally compressing the tactile data; and
deciding on the action on the basis of combined state data obtained by combining the state data, the first compressed data, and the second compressed data into one.

11. A computer-readable non-transitory storage medium storing a program for causing a computer to:
acquire state data of a robot, visual data of the robot, and tactile data of the robot;
decide on an action of the robot capable of accomplishing a task given to the robot on the basis of the state data, the visual data, and the tactile data;
generate first compressed data having a smaller number of dimensions than data obtained by combining the visual data and the tactile data by fusing and dimensionally compressing the visual data and the tactile data;
generate second compressed data having a smaller number of dimensions than the tactile data by dimensionally compressing the tactile data; and
decide on the action on the basis of combined state data obtained by combining the state data, the first compressed data, and the second compressed data into one.
